(19) United States
(12) Patent Application Publication
(10) Pub. No.: US 2021/0012513 A1
(43) Pub. Date: Jan. 14, 2021

(54) METHOD AND SOFTWARE SYSTEM FOR MODELING, TRACKING AND IDENTIFYING ANIMATE BEINGS AT REST AND IN MOTION AND COMPENSATING FOR SURFACE AND SUBDERMAL CHANGES

(71) Applicant: MotionVirtual, Inc., San Francisco, CA (US)

(72) Inventor: JunHo Park, Gyeonggi-do (KR)

(21) Appl. No.: 16/932,790

(22) Filed: Jul. 19, 2020

Related U.S. Application Data
(63) Continuation-in-part of application No. PCT/KR2018/007061, filed on Jun. 22, 2018.
(60) Provisional application No. 62/876,139, filed on Jul. 19, 2019.

(51) Int. Cl. G06T 7/246; G06T 17/00; G06T 7/10; G06T 19/20; G06K 9/00

(52) U.S. Cl. CPC G06T 7/251; G06T 17/00; G06T 7/10; G06T 19/20; G06K 2009/00932; G06K 9/00885; G06T 2207/30196; G06T 2219/2016; G06T 2219/2021; G06K 9/00214

(57) ABSTRACT

Methods and systems for creating 3D models of biological entities from different types of sensor data are provided. For instance, these methods can track an underlying network of nodes corresponding to blood vessel networks in 3 dimensions. Such methods adapt models to compensate for changes on the surface and in the structure that continuously occur in living entities, such as when blood flows, hands stretch, heads turn, and the like. These 3D models can then be used to perform functions such as motion tracking, biometric authentication, and visualizations in air (such as with Augmented and Virtual Reality) using 3D models as positional references.

### CROSS-REFERENCE TO RELATED APPLICATIONS

This application is a continuation-in-part of PCT application number PCT/KR2018/007061 filed on Jun. 22, 2018 and this application also claims the benefit of U.S. provisional patent application No. 62/876,139 filed on Jul. 19, 2019; the disclosures of both are incorporated herein by reference.

### BACKGROUND

The importance of motion tracking and authentication technology has grown across markets and applications.

In biometric authentication, there is a strong need to accurately verify a user's identity using their biometric data, which is generally considered more secure than user-generated passwords. As such, sensors, cameras and devices are more readily available to provide this data as are used for identification in a variety of modalities including readers for fingerprints, irises, facial recognition, DNA analysis, movement and voice related data.

Biometric information used in biometric authentication is unique to each person and can be represented by data values to uniquely identify each user. The biometric information may be expressed as a unique value for each user. Once identified, many functions can happen using this data, such as biometric authentication for secure access and tracking of individuals in crowds.

Each biometric authentication scheme has advantages and disadvantages in terms of types of sensors, processing speed, range of coverage and accuracy. Many of these methods transform 3D information such as fingerprints, irises and facial features into 2D representations used for unique identification.

### SUMMARY

Embodiments described herein provide an improved way to model biometric data and new methods for identifying, understanding, tracking and authenticating users.

The presented embodiments of the current technology relate to methods and systems for creating 3D models of biological (living) entities from different types of sensor data. These new methods create new assets, and ways of understanding structures of living entities (e.g., human users), such as an underlying network of nodes corresponding to blood vessel (e.g. vein) networks in 3 dimensions (x,y,z).

In addition, the methods include adapting models to compensate for changes on the surface and in the structure that continuously occur in living entities, such as when blood flows, hands stretch, heads turn, bodies run and jump and/or other transformations.

These 3D models can be used to perform functions such as motion tracking, biometric authentication, and visualizations in air (such as with Augmented and Virtual Reality) using 3D models as positional references.

The ability to create these unique models and being able to compensate for changes in shape and structure (including position, elongation, 6DOF etc.) provides a new level of stability and capability of the functions built on these models.

Motion Tracking is another technical field that is often associated with the field of artificial intelligence (AI) and object recognition. The embodiments described herein provide for the motion tracking function by using biometric data. While conventional designs use Visual Recognition algorithms to see the human form and recognize the shape and details of the body, the embodiments described herein read sensor data and creates 2D and/or 3D models of the biological object. Accordingly, the described embodiments can further track the object accurately, understand its shape and surface details, and differentiate the human form from other objects, animate and inanimate.

By combining the ability to create 3D Models of biometric data, track the changes and movements and uniquely authenticate the user from this data, our methods enable new capabilities.

For example, we can authenticate users by different parts of a person or different angles of visibility to known or stored, larger models and accurately authenticate them at a distance, without touching a sensor.

Users can be tracked and identified while in motion, even though the underlying structure is changing shape and they can be uniquely identified even in a crowd of people. One or more of the described embodiments can track a specific person or part of the person in a crowd, and differentiate those parts.

This capability is particularly useful in fields of AR and VR, where reference points for displaying images relative to a person's body parts are desirable. Particularly when there are multiple people in the field-of-view, being able to differentiate and identify each person uniquely along with each of their body parts is desirable.

One or more of the embodiments generate a 3D model from sensor data to create an accurate, lifelike, model that is a unique representation of a person with one or more possible poses, movements and shapes they become. By accurately sensing and calculating the shape of the person's vein network, at rest and/or in motion, and compensating for transformations, new functions based on these capabilities are enabled, including new ways to authenticate, track and model animate forms, and/or differentiate them from inanimate objects and other living beings.

Human structures continuously change and contort, on which biometric data, and related uses, are based. One of the challenges that this method addresses is to authenticate users via their biometric information such as blood vessel patterns (e.g., vein patterns), even though these patterns change shape, twist, stretch and contort, with the movements of living beings. For example, humans can make a fist or stretch their fingers or play piano, and the shape and internal structure of the hand changes. The nodes, bifurcation points, and vein networks bend and contort.

The method described within defines how to consistently track, authenticate, maintain vein coordinates and perform other operations when based on models of objects that change and transform.

Other vein-authentication methods are less secure, less reliable and limited. They rely on 2D representations, which are easier to spoof/fake and require viewing from a few/limited angles (usually from a single/common position) Methods described leverage two or more sensors to provide 2D and 3D views of veins networks which enables a new level of dimensionality or ability to authenticate from many directions.

User authentication can now be done with more accuracy, from many angles and are much more difficult to fake, particularly because the methods are based on 3D models of vein coordinates versus 2D approaches such as with fingerprints or 2D palm vein patterns.

The methods described herein as Reliability of Biometric Authentication Methods. They are based on the new understanding of living beings structure and implementation of representative 2D and 3D models with structure and surface analysis, 3D cell dynamics, 6DOF data about each coordinate in the subdermal network, and a probability model for matching objects even when their shape and position have changed.

Motion tracking that relies on visual recognition is inconsistent and computationally intensive. For the last 30 years, conventional approaches to tracking the motion of a human is to use object recognition algorithms. These algorithms look for specific human shapes, like the contours of a hand or the shape, distances, and proportions of details of a face. This method is even more difficult when the hand (or any body part) touches, holds or is obscured by an object; conventional systems must figure out what is the shape of the tracked body part and differentiate it from other objects and scene elements.

Motion tracking techniques are introduced herein that use directly detectable information, such as vein patterns, to indirectly estimate non-visible structures, such as bones. The methods described automatically see vein-patterns, which can be used to determine the shape of the body part being tracked, and differentiated from all other objects in the scene. Because, each vein pattern is unique, we can authenticate users and differentiate all people and body parts in the scene. This new method may reduce/eliminate analysis or complex object recognition to pick out objects; instead of conventional approaches that require the complex object recognition, we read sensor data, interpret the biometric information into 2D and 3D models of the biological object. This enables our technology to track the object, accurately, understand its shape and surface details, and differentiate the human form from other objects, animate and inanimate. For example, where conventional object recognition algorithms look for contours and patterns that can be used to identify the shape of a hand, our method is able to automatically determine that the object is a human hand and its shape because we see the biological data (from sensor data) and create models of the underlying vein networks in the right shape at any point in time. For example, conventional object recognition has difficulties in differentiating a hand from a cup held by the hand, but by tracking the vein networks of the hand, we can easily identify the hand and the shape thereof around the shape of a cup.

Continuous Authentication is Difficult because they rely on humans' features that may move and change. Most biometric security methods require the person to remain still so that a clear reading of their biometric data can be read and used to match in a database. For example, fingerprint, palm-vein readers and iris readers require users to be in the exact right spot, not to move, and view from a specific angle. Other security methods like Facial Recognition and Gate (walking) Analysis have higher rates of failure and are easier to trick by changing facial features and motion mechanics.

Methods described within combine our methods for motion tracking and authenticating living beings by creating 3D models compensating for changes in vein-network shape through a process we call Model Matching. Complex capabilities such as Continuous Authentication are possible by combining new capabilities such as motion synchronizing methods, tracking, modeling and authenticating.

Detailed and persistent coordinates are needed to enable functions related to the bodies of living beings in motion. In areas such as AR/VR, it is often desirable to have virtual items or interfaces consistently appearing at designated locations (e.g., on or about a particular portion of the human body). Or possibly, some technology may need to target a specific point on a human such as in giving an injection, or firing a laser, making an incision. This is difficult without the ability to know the exact spots, within a millimeter, of a person, who may or may not being in motion or have other reasons for changes in surface or subdermal features.

Methods described within include the creation of a network of coordinates related to vein patterns, unique to each person, and readable even if the shape or position changes. These coordinates and unique IDs for the person's vein patterns can be used as a reference for other operations such as the display of augmented reality images anchored to the location of specific biometric points. We create unique IDs and 6DOF information about each point in these networks, which can then be used for tracking of structure and surface features of animate objects, amongst other features.

Aspects, features, objects, effects or advantages of the embodiments are not limited to those described above. Other effects and advantages of the present technology will become apparent to those skilled in the art from the following detailed description in conjunction with the annexed drawings.

### BRIEF DESCRIPTION OF THE DRAWINGS

FIG. 1 is a flowchart representation of an exemplary process flow according to various embodiments of the present invention.

FIG. 2 is a flowchart representation of another exemplary process flow according to various embodiments of the present invention.

FIG. 3 schematically illustrates an exemplary method of model sensing by use of sensors according to various embodiments of the present invention.

FIG. 4 schematically illustrates structural and surface elements of a biological object that may be employed in methods according to various embodiments of the present invention.

FIG. 5 is a schematic representation of vein singularity points or vein network nodes that may be employed in methods according to various embodiments of the present invention.

FIG. 6 is a flowchart representation of an exemplary line matching and update propagation process flow according to various embodiments of the present invention.

FIG. 7 is a schematic representation of a two degree of freedom extension process according to various embodiments of the present invention.

FIG. 8 is a schematic representation of a six degree of freedom extension process according to various embodiments of the present invention.

FIG. 9 is a schematic representation of a surface analysis process according to various embodiments of the present invention.

FIG. 10 is a schematic representation of a dynamic equilibrium in the surface analysis process according to various embodiments of the present invention.

FIG. 11 is a flowchart representation of a model matching method according to various embodiments of the present invention.

FIG. 12 is another flowchart representation of a model matching method according to various embodiments of the present invention.

FIG. 13 is another flowchart representation of model matching methods with stereo biometric sensing and depth biometric sensing according to various embodiments of the present invention.

FIG. 14 is another flowchart representation of model matching methods according to various embodiments of the present invention.

FIG. 15 is a schematic representation of an example of motion modeling according to various embodiments of the present invention.

FIG. 16 is a schematic representation of a system for performing model matching according to various embodiments of the present invention.

FIG. 17 is a schematic representation of an exemplary multi-path matching method according to various embodiments of the present invention.

FIG. 18 is a schematic representation of an exemplary multi-path matching method according to various embodiments of the present invention.

FIG. 19 is a schematic representation of another exemplary multi-path matching method according to various embodiments of the present invention.

### DETAILED DESCRIPTION OF ILLUSTRATED EXAMPLES

The following terms have been used in the document:

Devices can include hardware modules/circuits and/or associated software modules configured to implement/execute functions, conceptual modules, or programming objects processing model data. For example, the devices can include sensors (e.g., cameras, infrared sensors, etc.), processors, and/or storage devices.

The term “system” means a set of connected things (hardware and software modules) or parts related to the process of modeling or model matching.

The term “model” represents a set of two-dimensional (2D) or three-dimensional (3D) data generated for or about an object. That is, the system may generate digital data for an object (target object) using one or more sensors. The system can store and manage the generated data as 2D or 3D one or more models for the object.

The term 6 degree of freedom or “6DOF” represents free motion of the object or points on the object in a 3-dimensional space. The free motion may be represented based on three-axis directions (e.g., x, y, z), the orientation between the three axes (e.g., relative coordinate system with x-axis, y-axis, z-axis), and/or the rotation around the three axes (e.g., roll/pitch/yaw or Euler angles). 6DOF can also represent a range of values which can have free motion, orientation, and direction values in a probability range.

The term “2DOF” or “3DOF” correspond to limited degrees of freedom versus the 6DOF. The 2DOF can represent free motion in two-dimensional space and the 3DOF can represent free motion in two-dimensional space and one rotation/direction which has an angle value. The 2DOF and the 3DOF can have a range of values or a probability range like the 6DOF.

The terms used herein may have the same meaning as commonly understood by one of ordinary skill in the art to which this technology belongs. It will be understood that terms should be interpreted as having a meaning that is consistent with their meaning in the context of the specification and relevant art. In some cases, particular terms may be defined to describe the embodiments in the best manner. Accordingly, the meaning of terms or words used herein should be construed in accordance with the spirit of the embodiments.

The following embodiments include one or more elements and features described below. Each component or feature may be considered optional unless otherwise expressly stated. Each component or feature may constitute an embodiment without being combined with another component or feature. Some of the elements and/or features may be combined to constitute an embodiment of the present technology. The order of the operations described in the embodiments may be varied. Some configurations or features of certain embodiments may be included in other embodiments, or may be replaced with corresponding configurations or features of other embodiments.

Descriptions of well-known steps, functions or structures incorporated herein may be omitted for brevity.

In the description, an expression “comprising”, “including” or “having” indicates the existence of a specific feature and does not exclude the existence of other features. The word “unit”, “module” or the like may refer to a software component, hardware component, or a combination thereof capable of carrying out a function or an operation. When a component is connected or coupled to another component, it may indicate a physical connection, an electrical connection, a wireless connection, or even a logical connection.

In the below descriptions, the singular forms “a”, “an” and “the” are intended to include the plural forms as well, unless the context clearly indicates otherwise.

In the description, the word “user” may be, but not limited to, an owner of a device, a user of the device, someone that passes and stands in front of a device, or a technician repairing the device.

Hereinafter, various embodiments of the present technology are described in detail with reference to the accompanying drawings. The description of the various embodiments is to be construed as illustrations of the present technology.

Specific terms used for the embodiments are provided to aid understanding of the present technology, and the use of such specific terminology may be changed into other forms without departing from the subject matter of the present technology.

We provide a new method for understanding living objects and creating new types of metadata about the object to enable capabilities such as authentication, motion tracking, changes in shape and surface features in motion, and augmented reality displays related to tracked objects.

Described herein are methods and system designs to generate a model of living objects, by using data from one or more sensors. The methods compare structure data and surface data between models (stored, streamed, real-time and in memory) in order to match points and create new, updated models.

This model matching method is used to track motion from streaming pixel data from one or more sensors. Various algorithms and techniques for performing matching between models, matching between streams, and matching between a model and a stream are disclosed.

A matching function is done between 3D models, 2D models or parts of models, and/or within different models, to enable new functions such as motion tracking and user identification and authentication. As matches of parts of 3D models are found, users can be uniquely identified.

The sensor data may be streams of 2D images from two or more cameras, or 2D images from a single camera and depth images from depth camera(s), and may use infrared data, RGB data, depth data or other data, which may be processed within our algorithm and used to create unique 3D models for living entities. One or more of the embodiments described herein can include a method and software system and design for performing matching between biometric models of biological object data, obtained from sensors, and compared and analyzed across 3D models, stored in memory or streamed in real-time. In addition, 2D data may be used to create 3D models of living organisms, each of which are unique to the individual and can be used for multiple functions such as motion tracking and unique identification of an individual.

The data gathered from sensors, which is interpreted, transformed and modeled by the system (via, e.g., software), relates to surface properties and the underlying networks of animate objects, including corpuscles, skin features, hair, vein bifurcation points, bones and other subdermal elements of the object. As is in all living objects, these biometric elements stretch and transform in shape as the object moves. The methods allow for accurate tracking and identification of the living beings by their underlying networks, even as the shapes change.

The method uses data from sensors as inputs to create 3D models of vein networks, unique identifiers for each point, other coordinates and related 6 degree of freedom (6DOF) data. These networks can be used to track and predict surface changes, shapes and detailed feature characteristics of the object, even in motion.

The method and/or the system can be configured for identifying and tracking the movements of points inside of animate objects while in motion (points streaming). Points are matched in different locations (points synchronizing) by their unique identification (unique IDs). More particularly, this biometric data can be used for biometric-based authentication and tracking of the detailed anatomy of the human body in motion. By matching the location of coordinates of vein structures at different points in space and inferring a 3D model of points within the vein structure of the animate object, many functions may be done on the model.

Since the distribution of veins is unique for each person, the finding of these patterns and use of them for unique identification, authentication, tracking and other biometric-dependent methods can use these vein patterns as they are revealed and coded into a machine-readable format.

Along with improving the accuracy of a process of authenticating a user, the effects of the embodiments of the disclosure are not limited to the above-described effects, and those skilled in the art may clearly derive and understand other effects, from the descriptions associated with the embodiments of the disclosure provided below. That is, those skilled in the art may recognize unintended effects, obtained as a result of implementation of the disclosure, from the embodiments of the disclosure.

The following discussion gives a high-level view of the system/software design and where different methods may be used.

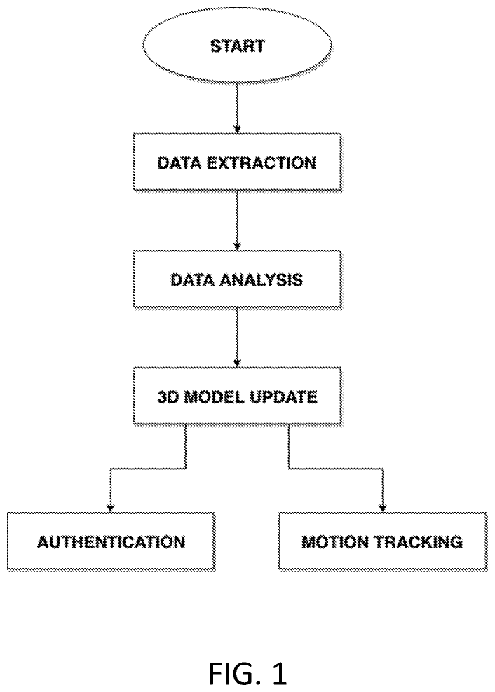

FIG. 1 illustrates a process flow related to an embodiment of this disclosure. The process diagram in FIG. 1 shows how data from sensors may pass through the system for various functional purposes.

Sensor data is extracted and processed so that it may then be analyzed and used to update 3D models with the methods described herein. The 3D model may then be used for various functional purposes such as for user identification and authentication or for motion tracking.

Please note that in FIG. 1, processes may begin at different points in the flow. Actions may start at any point in the flow. For example, a software process may begin at Data Analysis or at 3D Model Update or at Authentication. FIG. 1 describes a process of a set of functions and how they interact.

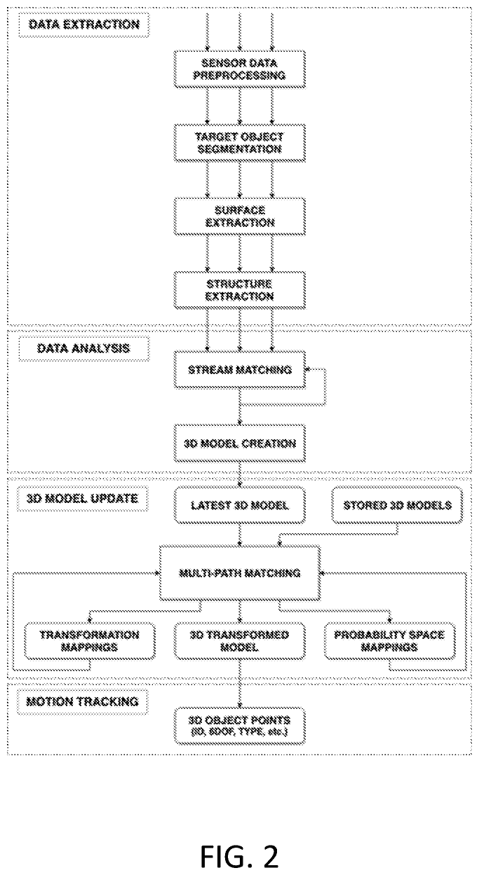

FIG. 2 illustrates an example process flow related to an embodiment of this disclosure. FIG. 2 includes the process from FIG. 1 but with more potential detailed steps that may occur as an example of how the overall process presented here may be implemented for motion tracking purposes.

In one or more embodiments methods for a system to perform multiple functions including 3D model creation and model matching. The method may include: generating a first model for an object utilizing one or more sensors; calculating the 6DOF value of a first point located on the first model; comparing the 6DOF value of the first point with the 6DOF value of a second point that is located in a second model being compared with the first model and matches the first point; and applying the comparison result to a third point adjacent to the first point in the first model, and determining the probability range of a fourth point that is located in the second model and matches the third point.

Different methods can then be used to provide different functions such as identify or authenticate individuals through pattern matches with these models. One method does biometric authentication by finding and tracking veins in parts of the user's body and creating a 3D representation of that part of the body. Other methods of biometric authentication use vein distributions as well, since they are unique to each individual. The method is different because it preserves the 3D nature of veins in humans.

In one embodiment, the probability range may be a numerical representation of a cell in which the fourth point may exist in space.

In one embodiment, the 6DOF value may be a value or a range value indicating one or more points have moved in 3D space, orientation, and rotation.

In one embodiment, the probability range may be determined by reflecting the elastic modulus between the first point and the third point in the comparison result.

In one embodiment, applying the comparison result may include calculating one or more of the directions of the position displacement change, the amount of displacement in rotation, and/or the amount of change in rotation between the first point and the third point.

In one embodiment, applying the comparison result may further comprise applying the direction or the rotation of the position displacement between the first point and the third point, to a transformation matrix defined for the first model and the second model, and obtaining a direction or a rotation of a position displacement between the second point and the fourth point, from the transformation matrix.

In one embodiment, the amount of displacement and the amount of change may be a value based on an absolute coordinate system, a value based on a relative coordinate system generated based on the axis of a reference point, or a value based on a relative coordinate system resulting from transformation between two matching points.

In one embodiment, applying the comparison result may include geometrically representing the probability for the position, rotation or direction based on a given space figure.

In one embodiment, model matching between the first model and the second model may be applied to one or more processes for comparing structure data of the object and/or for comparing surface data of the object.

In one embodiment, the method may further comprise determining whether the first model and the second model are matched. It may be determined that the first model and the second model are matched with each other, if the comparison result of the structure data and the comparison result of the surface data are above or equal to a threshold value.

In one embodiment, upon determining that the first model and the second model are matched with each other, the comparison result of the structure data and the comparison result of the surface data may be transferred to scaled-up data.

In one embodiment, the method may further comprise extracting feature data from the structure data and the surface data. The feature data may be generated by utilizing one or more of intensity, color, surface normal, curvature, vein, skin line, and/or relationship between features for a particular point.

In one embodiment, the structure data may be data about the vein distribution of the object and the surface data may be data about the skin of the object. The structure data and the surface data may be two-dimensional data or three-dimensional data.

In one embodiment, if the data constituting the first model is changed before determining whether the first model is matched with the second model, the changed data of the first model may be compared with the data of the second model.

In one embodiment, the method further comprises tracking a change of the 6DOF value of the first point and a change of the 6DOF value of the second point for a duration of time, and generating a motion signature for the first model and the second model respectively by using the change of the 6DOF values.

In one or more embodiments, a system can be configured to perform 3D model creation and matching. The system may include a sensor unit configured to obtain data about an objector the system may accept data from sensor units external to the system. The system may contain a software or hardware controller configured to match two models based on the data obtained from the sensor unit. The controller may generate a first model for an object utilizing one or more sensors of the sensor unit, calculate the 6DOF value of a first point located on the first model, compare the 6DOF value of the first point with the 6DOF value of a second point that is located in a second model being compared with the first model and matches the first point, and apply the comparison result to a third point adjacent to the first point in the first model to determine the probability range of a fourth point that is located in the second model and matches the third point.

In one or more embodiments, a computer readable storage medium, either internal or external to the system, that includes data, methods and/or 3D model to be used for 3D model creation and matching purposes.

The model matching method may include: generating a first model for an object utilizing one or more sensors; calculating a 6DOF value of a first point located on the first model; comparing the 6DOF value of the first point with the 6DOF value of a second point that is located in a second model being compared with the first model and matches the first point; applying the comparison result to a third point adjacent to the first point in the first model to determine the probability range of a fourth point that is located in the second model and matches the third point; finding patches of mesh from one data source or model within another patch or 3D model; and matching biometric signatures or identifiers within other models or data storage systems.

There are many new applications and features that are now enabled through this unique understanding and methods of processing sensor data about corpuscle and other biometrics data of living beings.

Method for Sensing Objects and Details

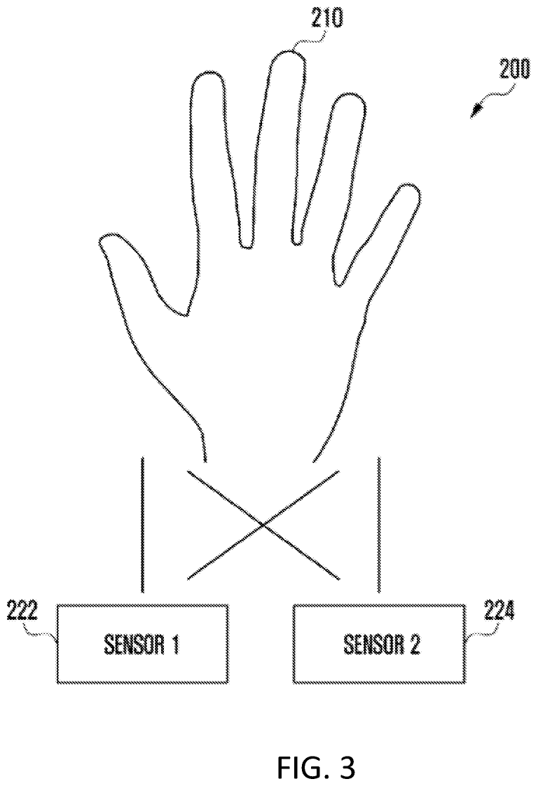

FIG. 3 illustrates one of various methods of model sensing by using sensors. The system can generate and store data associated with an object 210 by transmitting optical signals of various wavelengths to the object and receiving reflected optical signals using one or more sensors that can then be processed to generate further data. The system may collect data using one or more sensors (222, 224).

Discussion of Sensors

By way of example, the transmitted signals may be infrared (IR), depth sensing frequencies or laser lights and may be sensed with stereo cameras, depth sensors, time-of-flight (ToF) sensors, thermal cameras, IR cameras, IR-RGB cameras, RGB cameras, body scanners (full body, hand, face, etc.) or any other type of sensor. In addition, various methods such as Structured Light, Time of Flight, Stereo Pattern/Feature Matching, 3D reconstruction, 3D feature extraction, 3D model creation, LIDAR, speckle interferometry, and infrared proximity array (IPA) can be utilized to collect data about an object. Other sensors may include ultrasound and thermal.

The system can also collect and store this data about an object for analysis, search, matching, 3D model creation and other functions. In addition, different types of data from different sources, such as when one or more depth sensors and one or more biometric sensor(s) operate together, can be merged to create 2D and 3D biometric data and models. That is, the sensor 1 (222) and the sensor 2(224) in FIG. 2 can be different types of sensor such as biometric sensor and depth sensor, thereby obtaining different types of data by using different sources. By using a combination of different types of sensors, such as with depth and biometric sensors, model creation and search provides improved accuracy and speed.

Also, the biometric sensor(s) could be utilized for depth sensing not only for 3D reconstruction of biometric data and 3D models, but also for transmission and reception of structured light to biometric objects by merging the depth data and biometric data together. The processing of merging the depth data and biometric data together could be conducted in a single domain or multi-domains. If the merging process uses a single domain, the transmitted pattern (structured light reflection) can be processed to remove the pattern in the frame and the image could be re-used for biometric pattern extraction as well. By way of illustration, when one or more RGB cameras or IR-RGB cameras are used with biometric sensors, then color data (2D or 3D) could be meshed on depth data (or 3D biometric data) in 3D space so that multi-spectral models can be created. Further, the 2D or 3D RGB data can be subtracted from the 3D biometric image or pattern to improve biometric image quality. This is because the IR spectrum may contain skin data and vein data and the RGB spectrum may contain skin data. By subtracting the RGB image to the IR image, better quality of biometric data could be obtained in 2D or 3D.

This Method for Sensing Objects and Details can use one single frame or multiple frames from different devices, to conduct 2D pattern detection, stereo pattern detection or 3D pattern detection, 3D model creation, search and pattern removal (or pattern subtraction). These functions may happen by software or algorithms implemented or at the hardware level. When using multi-domain like one or more depth data and biometric data, a single model, combining these different data types creates a more well-defined and descriptive model.

When the 3D data and biometric data of the object are obtained concurrently, from two or more devices or sensors from different perspectives, the Methods create the result of estimating the object's accurate location, convert the data into probability ranges, and may apply this data to a process like 3D-model creation or model-matching processes (described later).

The method may also utilize 2D vein images from other systems in combination with the generated 3D models described here. For example, data from 2D palm vein scanning systems may be used to allow continuous authentication in 3D for the same individual.

Method for Model Structure and Surface Modeling

The biometric system may generate a model of a biological object by processing data collected using one or more sensors. In addition, the biometric system may collect and process data in real time and may generate a stream. The model may refer to two-dimensional or three-dimensional data, and the process for creating the model may be post-processing of digital data.

Example Structure & Surface Elements of Animate Object

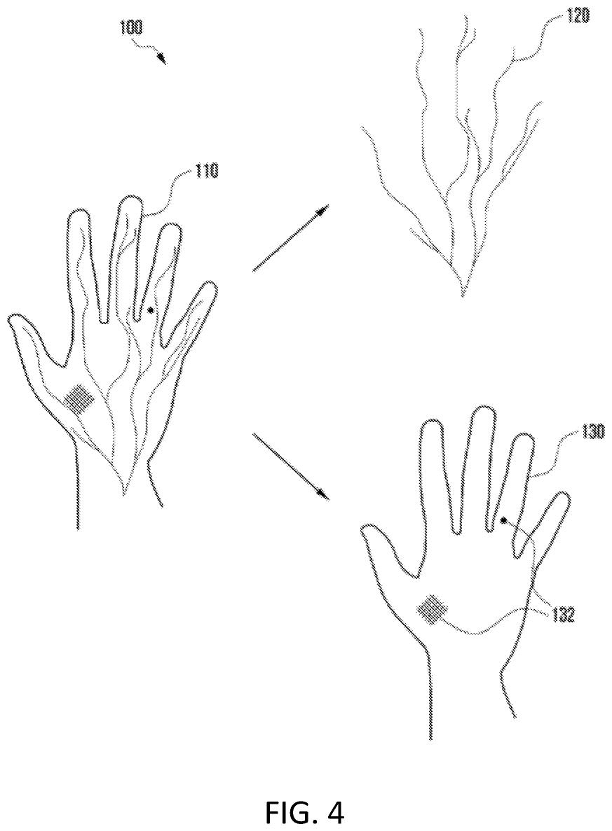

FIG. 4 illustrates examples of the structural and surface elements of a biological object that may be used according to various embodiments of the present technology. In FIG. 4, the object being modeled is depicted as the back of a human hand but the system is not limited to the back of the hand and may model any part of a biological body. The system may utilize one or more sensors of different types to collect data about the object 110 and generate a 3D model of a part of the body containing veins.

In animate objects, such as living humans, the constituent parts that makeup the object may not be rigid. While they stay connected to the object, they may also move independently in three dimensional space through mechanical capabilities or may deform due to internal or external forces. In other words, our skin, veins and other biological parts stretch, contract, twist, and move in space, in living beings. So, functions based on these objects, such as palm vein authentication or tracking of a waving hand, may be compensated with a range of possible and probable locations of any point on the hand. The information in this document describes in detail this method for tracking the underlying network elements of corpuscles and creating new assets, like updated 3D models on which some functions may rely.

Here, the object 110 (FIG. 4) can be largely divided into the structure and the surface, where the structure and the surface are different representations of the organic object and can be combined to create different views of the object 110.

The distribution 120 (FIG. 4) of veins present inside the back of the hand may correspond to the structure of the object 110.

Method for Vein Distribution Analysis

In particular, the veins are distributed in three dimensions and are composed of points represented in X, Y, Z space. The distribution of vein points can also be divided into lines, networks and areas. The vein points may be connected in three-dimensional space, referred to as a connected network whereby each point connects to one or more neighboring points. The procedure for analyzing the vein distribution will be described later.

Method for Structure & Singularity Point Analysis

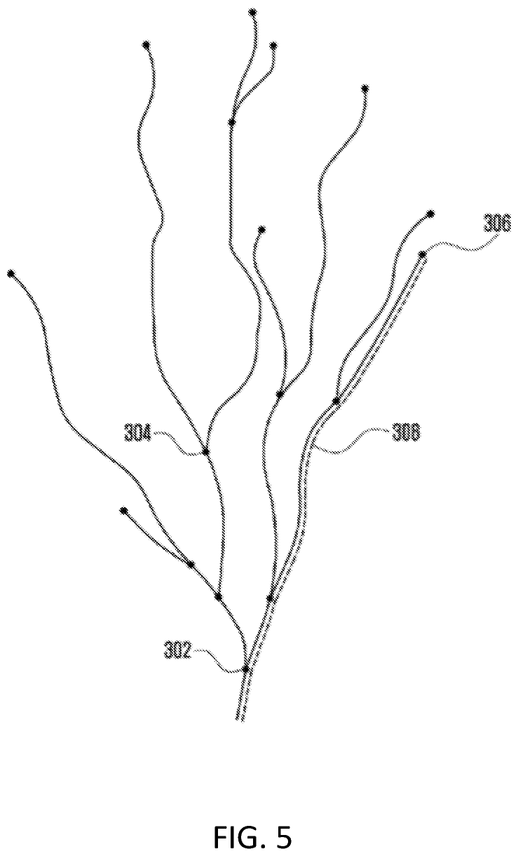

The structure analysis process to be described later is based on the structure theory of veins. The structure theory indicates a way of interpreting a 3D vein structure in terms of point, line, network, attributes and area. FIG. 5 illustrates an example vein structure.

FIG. 5 illustrates an example of vein singularity points or vein network nodes to illustrate a structure analysis process in accordance with various embodiments of the present technology.

Further regarding the structure theory, the points may include a bifurcation point (302, 304, 306 in FIG. 5), a singularity point that is easy to observe in the vein structure. A point that is easy to observe may mean that the intensity of the signal sensed by the device through a sensor is relatively large compared to other positions or that the point is recognized as the same point each time the object is observed from one or more units. A line refers to a straight line or curved line created by connecting two or more points (308 in FIG. 5). A network may refer to connected paths within a mesh of points. By connecting two points (302 and 306 in FIG. 5) selected from a plurality of points lines within the network are used to describe the 3D model of the biometric object being observed and modeled.

The described features (points, lines, networks, and areas) and the orientation and value (scale or size) of the feature points vary by distance, rotation, direction, sensing angles, image scale changes. The biometric or pattern data may change continuously (e.g., blood expansion changes the shape or the network, location of points and brightness of lines in IR spectrums) and some feature extraction methods could be introduced to extract invariant and variant features from the bio-data. For example, invariant features for rotation and distance such as histogram of gradients, which lists gradients of neighbor points with a histogram, and variant features like bifurcation points, which differ by scale, may be extracted from the data set or model for accuracy of model or better performance during usage. The histogram of gradients could be used in 2D stereo matching and 3D model matching. When the histogram of gradients is used in 3D model matching case, the gradient vector could be set to the normal of the surface.

The device, software application or algorithm performing the model matching processes (described below) may analyze the structures between models based on this structure theory. First, as described above, the device can see an object by utilizing one or more of various sensors. For example, the device may recognize an object (e.g., veins inside the back of a human hand) by transmitting an optical signal and sensing the reflected optical signal and generating structure data. Our analysis of this data is used by our unique modeling method to create a 3D representation of these objects for computational processes like unique identification and motion tracking.

The process of creating 3D models is one of transforming a point at a specific position of the vein structure into a three-dimensional position, and in relation to other observed points in the network. This process may be repeatedly performed to get many positions for each point and dynamically create and adjust the model as the object is in motion. This forms a new asset we call the Motion Signature, which is described in detail below.

Based on the vein structure theory described above, this transformation process may be performed in sequence along the lines and networks for the whole vein structure to be identified and recreated in a 3D model. For example, the system may perform the transformation process for the position 302 in FIG. 5 and then perform the transformation process for the positions present along the line 308 to reach the point 306. When the vein structure for one line is identified, the structure analysis may proceed by comparing the lines between different models created by applying algorithms to different sensor sources.

Method for Tracking Morphological Properties

The human body, as a living organism, can significantly change when it naturally functions. That is, natural bodily functions are constantly occurring, changing the properties of various parts of the body. For example, blood is continuously circulating, causing blood vessels to expand and contract. A model of one or more parts of a living organism can allow for such natural changes but also adapt in a way that remains within the range of possible biological configurations.

Beyond veins, other morphological elements of the object may also be referred to as structural elements when they have topological properties whose connectivity is preserved through deformations, twistings, and stretchings of the object. For a biological object, these could include palm and skin lines, joints, bones, muscles, tendons, etc. Certain structural elements may be detected directly with one or more sensors and other structural elements may be indirectly derived. Together the structural elements make up the structure of the object.

The skin 130 (FIG. 4), constituting the outside portion of the object 110 (FIG. 4), may correspond to the surface of the object 110. Characteristic points 132 (FIG. 4), such as hairs, fingerprints, wrinkles, scars, nails and pores, located on the skin 130 may also constitute the surface of the object 110.

The structure and surface points make up the entirety of the model of the object and each have state in three-dimensional space and are capable of 6DOF movement. Beyond 6DOF position and orientation information, the state of a point may also include velocity, acceleration, color, type, and other properties of the point.

Method of Probability Spaces for Ranges of Node Data

To improve accuracy of results related to uncertain probabilities or intermittent errors created by external factors like light, hardware failures, etc., uncertainty factors may be applied to increase the range of probability to compensate for data anomalies. When the data is converted into a probability range, an error may be calculated based on camera depth and image calibration data. In cases where a sensor may capture a contrast image of light reflected from biological material, the signal may be scattered or include interactions with components like cells that blur and add variability between different time frames. Uncertainty may be added for factors caused by biological properties. The factors may be applied and a probability range with improved certainty may be provided.

Methods for Model Matching Process

Next, a description is given of an example for performing model matching by analyzing the movement and rotation (direction) of the structure and the surface. Here, model matching may refer to a process of comparing a model being analyzed to determine the similarity between two models or pieces of models within other more complete models. Data models that are being compared may be a pre-stored model or any real-time time data stream or other representation possible of 2D or 3D data or models. The two models can be compared to build a 3D model based on these comparisons of different 2D or 3D data sources. In particular, a method for efficiently performing model matching even in an environment where the object moves in real time in the space is proposed as an embodiment. The proposed method is based on the analysis of the structure and surface described above.

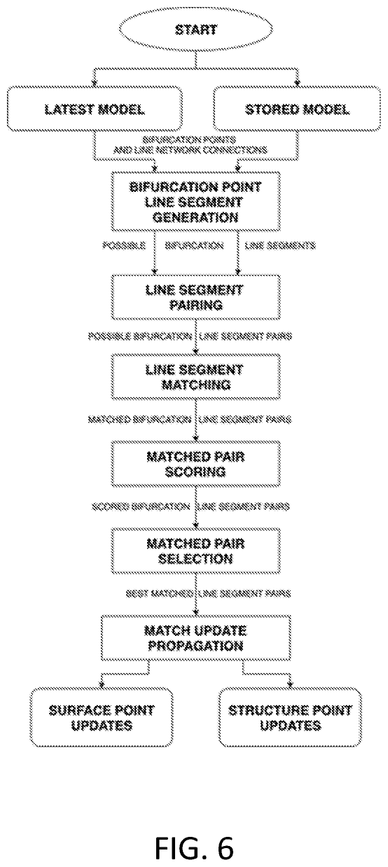

FIG. 6 illustrates an example of line matching and update propagation process flow related to an embodiment of this disclosure. FIG. 6 illustrates how vein bifurcation points stored in 3D models may be processed to determine matching line segments that may then be used to update position, orientation and probability information in the 3D models, ultimately improving their accuracy. The bifurcation points may be paired during a line segment generation process that results in a number of potential line segments. The line segments generated for each model may then be paired into possible combinations. Each of these line segment pairs may then be scored based on match quality with the top matches being selected to be used in updating the surface and structure information in the models.

In the above description, the line comparison process is described as an example of structure analysis. However, the structure analysis is not limited to the process of comparing lines; the comparison process can also be performed in terms of network or area in the vein structure described above. The specific position (i.e., point) at which the transformation process for the vein structure begins may be a bifurcation point. However, the embodiments are not limited thereto, and the transformation process may be initiated at any point in the structure data.

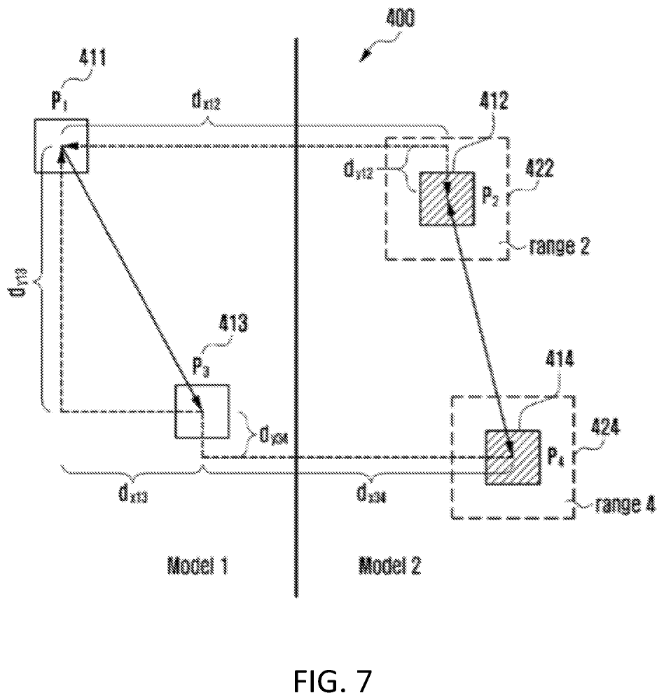

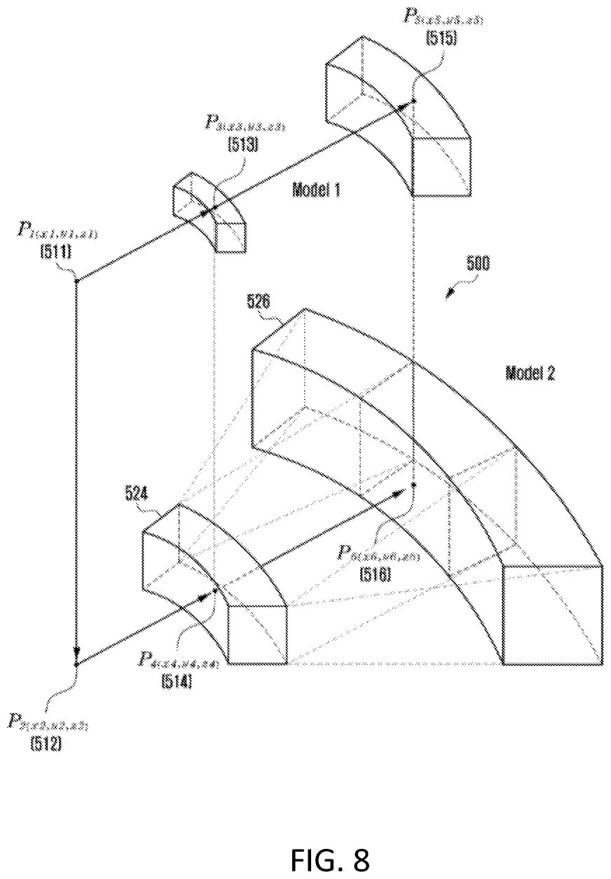

With reference to FIG. 7 and FIG. 8 (below), a description is given of basic concepts applied to the analysis of the structure and surface in model matching.

FIG. 7 depicts a 2DOF extension process in accordance with various embodiment of the present invention.

2DOF Stereo Matching

2DOF matching process can be used for stereo feature/model matching or stereo points matching which compare 2DOF data from multiple images to make 3D reconstruction data. This method can be performed with stereoscopic methods or combination of methods including stereoscopic approach. In case of using 3DOF, a freedom of direction/rotation/angle between the first 2DOF in the first image and the second 2DOF in the second image could be added to the 3DOF.

In FIG. 7, consider P1(411) and P3 (413) first for model 1. P1(411) is one of plural points arranged in two dimensions in model 1 and is separated from point P3 (413) of model 1 by dxu in the x-axis direction and dyu in the y-axis direction.

Next, for P2 (412) and P4 (414) in model 2 different from model 1, P1(411) is spaced apart from P2 (412) by dx12 in the x-axis direction and d2 in the y-axis direction, and P1 (411) and P2 (412) are matched with each other. When P1(411) and P3 (413) have 2DOF, the displacement between P1(411) and P2 (412) may be represented by dx12 and dy12, and the displacement between P3 (413) and P4 (414) may be represented by dx34 and dy34.

A probability theory may be applied with respect to FIG. 4. When points P1(411) and P3 (413) having 2DOF (x, y) in model 1 of a given object are matched with certain points at specific positions in model 2 to be compared, we cannot be sure about the exact position but we can assume that the solution exists within a certain range. For example, when the displacement between matching points P1(411) and P2 (412) is represented by a 2DOF difference (dx, dy), finding an accurate point with dx and dy values in a model pre-stored in the device or another model may correspond to finding the exact position (i.e., unique solution) described above.

On the other hand, based on the probability theory that determines the range in which the solution exists instead of the absolute solution with exact points; a point having a value in range 2 (422) specified based on a specific probability can be found instead of the displacement dx and dy between matching P1(411) and P2 (412). Here, the accuracy of model matching considering such a range is determined by how wide or narrow the range is. In other words, reducing the range can find the unique solution closer to absolute reality (with a probability of 100 percent) and widening the range can reduce the probability of having the exact solution. This method allows for accurate computational processes without perfect coordinates, so that the target solution is ensured to be within the range.

When the structure and surface data of model 1 correspond (within the defined range of variation) to the structure and surface of model 2 in two models being compared (model 1 and model 2), the position and orientation (6DOF) of all the data in model 1 can be a comparison reference, and the 6DOF range (probability) value of each point relative to the comparison reference includes the position and direction value of data of model 2. Through various probability calculations, the probability values of the data of model 1 can converge to a specific value with the decreasing range. If the data of model 2 are included in the convergence range or probability, it can be said that the two models being compared match each other. That is, the probability range of one point of model 1 may initially include all the points of model 2, and may correspond to one point of model 2 or have a probability of a convergence range after the matching ends successfully. The probability of a convergence range may include one or more points based on discrepancies, flexibility, and/or errors of the object model in comparison to actual data. Our method allows for differences between difference devices to be reconciled into our output model for use within applications.

As an illustrative example, in FIG. 7, when the 2DOF values of P1(411) and P3 (413) are known accurately and are accessible, the relationship between P3 (413) and P4 (414) can be analyzed based on probability theory. P2 (412) is in range (422) in the relationship between P1(411) and P2 (412), and the position of P4 (414) is separated from the position of P3 (413) by dx34 and dy34. Here, if the relationship between P3 (413) and P4 (414) has the same probabilistic elastic modulus as the relationship between P1(411) and P2 (412), the displacement values (dxu and dyu) between P1 and P3 can be converted into probabilistic values and added to already known range 2 (422) between P1(411) and P2 (412) This result can be converted into a range value (range 4 (424)) of P4 (414) that can be matched with P3 (413).

That is, when the range of displacement values between P1(411) and P2 (412) is known and the displacement values between P1(411) and P3 (413) are known, the range of displacement values between P3 (413) and P4 (414) can be inferred or predicted by the device. The range of the displacement values (dx34 and dy34) approaches range 4 (424) in proportion to dxu and d 3 from range 2 (422) between P1(412) and P2 (412). As an illustrative example, the x-axis value of dxu has an elastic modulus of dx and the y-axis value has an elastic modulus of dy, and these correspond to an increase, decrease, or change in the x-axis probability range for dx and the y-axis probability range for dy, respectively. Likewise, an elastic modulus of drx for the x-axis value of dyu and an elastic modulus of dy-y for the y-axis value may be translated into an increase, decrease, or change in the x-axis and y-axis probability ranges, respectively. When the x-axis probability range change amount (dxu-x, dyu-x) and the y-axis probability range change amount (dyu-x, dyu-y) described above are added to range 2 (422), the probability ranges of range 4 (424) is determined.

Alternatively, when the 2DOF displacement amount is integrated from P1(411) to P3 (413) with respect to elastic moduli dx-x, dx-y, drx and dry and added to the probability range value of range 2 (422), the probability ranges of range 4 (424) may be obtained.

As described above, when a particular point in one model (model 1) is represented as a probability range in the corresponding model (model 2), the probability theory can be applied in sequence to adjacent points. If the probability theory is applied in sequence to adjacent points, the matching result of one point can affect the DOF of the next point, resulting in a continuous effect that affects all DOF points of the compared models. The degree of this influence is determined based on the probability described above. This probability may be adjusted by the user, may be automatically determined according to the operation of an algorithm or program, or may be updated and managed in real time in consideration of an external environment or parameter.

As such, it is possible to specify the arrangement of plural points and positional relationship there between based on the probability. The advantage of this probability-based extension scheme in the model matching process is that it reduces the total number of cases by controlling the probability when the range that other nearby points can have is probabilistically determined from the DOF of a particular point. Different probabilities can be used based on usage needs for better accuracy and processing speed.

6DOF Model Matching with Probability Theory

FIG. 8 depicts a 6DOF extension process in accordance with various embodiments of the present technology.

In FIG. 8, a description is given of a 6DOF extension process based on the 2DOF extension process described above with reference to FIG. 7. FIG. 8 shows an example in which probability computation based on the probability theory described above and is applied in the 6DOF extension process.

The probability theory (or probability computation based on probability theory) applied to the 6DOF to be described in FIG. 8, unlike FIG. 7, correspond to a computation procedure based on a range given in a 6DOF space. For example, a position (x,y,z) in space can be defined within a cuboid range represented by 10<x<20, 10<y<20 and 1000<z<1500, and this cuboid range is a numerical representation of the range that one cell can exist. Alternatively, the probability theory can be understood and be applied as the relationship between points that exist as probabilities within a continuous range based on Brownian motion, particle motion in quantum mechanics, or wave theory. By reducing the radius of motion, it is possible to reduce the range of motion or vibration of the cell in the space, and the accurate position value can be obtained.

In this case, the direction from the origin in space to a given position xyz can be represented by Euler angles (yaw (vertical axis), pitch (lateral axis), roll (longitudinal axis)), Tait-Bryan angles, or an independent coordinate system (e.g., axisX, axisY, axisZ). The cases representing probabilities through Euler angles or Tait-Bryan angles may be divided into x-y-z, x-z-y, y-z-x, y-x-z, z-x-y, and z-y-z, which may then correspond to yaw, pitch, and roll. Probabilities can be represented by a range value between [−PI, PI] (i.e., −PI˜PI), [−2PI, 0], [0, 2PI] for yaw/pitch/roll. In addition, axisX, axisY and axisZ can be separately represented by independent direction coordinate systems, or represented mathematically by two or more combined coordinate systems.

In FIG. 8, the relationship between P1 (x1, y1, z1) (511) and P2 (x2, y2, z2) (512) is described first. It can be assumed based on the probability theory that the spatial position of P2 (512), one of the points that can be matched with P1(511), is within a 3D candidate space (or 3D range). P1(511) and P2 (512) can each be represented by a 6DOF value with the position and direction (rotation) of three axes on a three-dimensional space. Then, a 6DOF value (6DOF 12) between P1 and P2 can be obtained by comparing the 6DOF value of P1(511) with the 6DOF value of P2 (512). This is a concept corresponding to the displacement value of 2DOF described above with reference to FIG. 4, and can be defined by a position difference value (dx, dy, dz) in space and a value in the transformation coordinate system with three direction (rotation) axes. The three-axis transformation coordinate system can be obtained by transforming the three direction axes into a matrix and finding the corresponding transformation matrix. Here, the 6DOF value (6DOF 12) between P1 and P2 can be specified as a range value by applying the probability theory rather than one specific value. This is described in more detail later.

P3 (x3, y3, z3) (513) is located in the same model as P1(511). Assuming that P4 (x4, y4, z4) (514) is one possibility of being matched with P3 (513), the probability range of P4 (514) may be specified by the 6DOF range (524), and it can be said that P4 (514) belongs to this possibility. Here, the relationship between the relative 6DOF value (6DOF 12) between P1 and P2 and the relative 6DOF value (6DOF 34) between P3 and P4 can be represented by 3D position and rotation based on the concept of probability similar to that of the 2DOF case described before.

To sum up, 6DOF_12 is related to 6DOF value that transforms the 6DOF value of P x1y1z1xAxis1yAxis1zAxis1 to the 6DOF value of P x2y2z2xAxis2yAxis2zAxis2, and 6DOF 34 is a relative 6DOF value that transforms the 6DOF value of P x3y3z3xAxis3yAxis3zAxis3 to the 6DOF value of P x4y4z4xAxis4yAxis4zAxis4. However, this transformation can include a conversion into a probability range in a space including the accurate actual value. In some embodiments, the transformation can be different or separate from a conversion into specific position and direction values. Here, the value of 6DOF 12 and the probability of 6DOF 34 may interfere with each other or affect each other.

The 3 position axes and the 3 direction axes of the above 6DOF probability can be calculated separately. If P1(511) and P3 (513) are adjacent and the displacement of 6DOF 12 between P1(511) and P2 (512) is similar to the displacement of 6DOF_34 between P3 and P4, it is highly likely that the positions of P2 and P4 that can be matched therewith are adjacent to each other. Additionally, if the direction values of P1 (511) and P3 (513) are similar and the direction values of 6DOF 12 and 6DOF 34 are similar, the direction axis values of P2 and P4 that can be matched therewith may also be similar to each other.

When the 6DOF values of P1 (511) and P3 (513) of the comparison model are known and the 6DOF value (6DOF 12) between P1(511) and P2 (512) is represented as a probability, 6DOF 34 between P3 (513) and P4 (514) can be estimated. The value of 6DOF 34 can be predicted by applying the probability theory to the position difference between P1(511) and P3 (513), the direction axis difference there between, or the difference in direction transformation matrix there between. Here, the probabilistic elastic modulus described above can be applied.

The elastic modulus can be applied to the displacement for the distance or 3 position axes as a constant, as a value proportional to the first, second, or nth derivation, or as a value derived from other mathematical equations. The elastic modulus can also be used to calculate the amount of change in the direction vector for the displacement or distance of the position X/Y/Z axes or the amount of change in the rotation axes. The vector change amount of the direction vector (axisX, axisY, axisZ) or rotation (yaw, pitch, roll) for the displacement of the position X/Y/Z axes, or the amount of change in direction and rotation due to the change in angle or distance may be applied as a constant, or may be represented by a mathematical equation including the first, second, or nth derivation.

For example, when the displacement of the direction or rotation of P1(511) or the amount of change in distance is known, it is possible to predict how the direction or rotation axis values change along the path from P1(511) to P3 (513). The displacement or distance in the rate of change of directions or rotations may be a displacement based on a value in an absolute coordinate system, be a displacement based on a value in a relative coordinate system generated at the direction or rotation axis of the reference point, or a displacement based on a relative coordinate system for the direction or rotation transformation between the reference point and the matching point of another model being compared. In addition, the rate of change in direction or rotation may be a rate of change in direction or rotation in an absolute coordinate system, be a rate of change in direction or rotation in a relative coordinate system generated at the direction or rotation axis of the reference point, or be a rate of change in direction or rotation in a relative coordinate system for the direction or rotation between the reference point and the matching point of another model being compared. Such displacement or rate of change in direction or rotation along the distance may also be a probability range value, to which the above-described probability theory is applied.

Meanwhile, if the 6DOF value between P2 (512) and P4 (514) is additionally known, it is possible to find the probability range of 6DOF_34 by considering all of 6DOF_12, 6DOF 13, and 6DOF 24. Since the device already knows the 6DOF value of P3 (513), if the probability range of 6DOF 34 is found, the range value of 6DOF 4 can be found.

Hereinabove, a description is given of calculating the 6DOF range value of P4 (514) from P1(511), P2 (512) and P3 (513) by applying the probability theory. After finding P4 (514), this procedure may be extended in a similar way and applied to calculating the range value (526) of 6DOF 6, being the 6DOF range of P6 (x6, y6, z6) (516), from P3 (513) and PS (x5, y5, z5) (515).

In addition, the position and direction or rotation probabilities can be geometrically represented by using a given space figure preset, machine-learned, or contextually applicable. For example, for each of the X, Y, and Z axes, one direction axis can be independently represented as a volume or surface value in a sphere, cuboid, or more complex mathematically designed three-dimensional space. Then, the probability can be represented by applying mathematical inequalities to the surface or volume of such a figure. Alternatively, some or all of the three direction axes can be stored together in one geometric model. The geometric model stores a specific probability for a volume or surface, and can be used directly for probability operations to be described below.

One or more of operations such as initialization, expansion, subtraction, and multiplication may be applied in sequence or in combination to the probability represented in a manner described above. Initialization refers to the process of returning a geometric probability model by transforming a given initial direction value into a probability range.

When transferring a probability of the initialized probability model (i.e., representing a probability range value) to an adjacent cell, expansion refers to the process of geometrically expanding and returning the probability based on the elastic modulus of the cell with respect to the distance or displacement between adjacent cells, or based on the rate of change in direction or rotation with respect to the distance or displacement.

Subtraction refers to the process of identifying the intersection between the geometric model or range probability of the cell and the geometric model or range probability received from a neighbor cell and returning the intersection.

Multiplication refers to the process of converting displacement information of one model (existing as one range among the XYZ ranges on space) into displacement information of another model by multiplying the displacement between adjacent cells in the same geometric model and a matrix generated (i.e., transformed) by a direction or rotation value together. Here, the rate of change in direction or rotation with respect to the distance or displacement can be applied. As the direction or rotation axis changing with the displacement in model 1 is applied as matrix multiplication, the displacement in model 2 can be obtained more accurately.

The matrix operations described above can be a process of converting the direction or size for 3 direction or rotation axes of one cell into a 3×3 or 4×4 matrix or a probability matrix composed of variables having a probability range, and deriving a probability position by applying matrix operations to the displacement value (vector) between the cell and the adjacent cell. The probability theory described above (i.e., probability calculation based on the probability theory) can be applied between a given cell and its adjacent cell, which is represented by the influence of one cell on another cell. A similar approach can be applied to the 6DOF probability operation for P x1y1z1, P x2y2z2, P x3y3z3, and P x4y4z4, or to the relative 6DOF probability operation therebetween.

Meanwhile, all the cells of model 1 can have the same probability elasticity (or, probabilistic elastic modulus) and the same rate of change in direction or rotation with respect to the distance or displacement, or have different probability elasticities (or, probabilistic elastic moduli) and different rates of change in direction or rotation. Each cell may also have a unique value. Each cell has a 6DOF probability range absolutely or relatively to the neighbor cells. As such, for the relative 6DOF value, which converts a cell of model 1 into a cell of model 2, the accuracy of probability calculations can be gradually increased by simulating model matching through pre-storing or machine learning. If the relative 6DOF value is used within a given range, it can be used for tracking. Here, because the amount of change in position and rotation may be limited over time, the solution is found within the limited range. In this case, the position and direction can be tracked for all the cells, which will be described later. This indicates that all components including feature points can be uniquely identified and stored with respect to the sensing model, and indicates that the change in direction or position of the surface can be learned for an absolute coordinate system, a relative coordinate system generated by the relationship between neighbor cells, or a relative coordinate system between cells of model 1 and model 2 being matched.

To sum up, in the case of assuming 6DOF, it is also possible to determine the positional relationship and directional relationship in sequence for adjacent points based on the probability theory. When the probability-based method described above is applied in the model matching process for three-dimensional models, controlling the probability makes it possible to reduce the coordinates on the space that adjacent points can have. Hence, it is possible to reduce the computational complexity and time required for the entire calculation process. In particular, the 3D model of 6DOF has a higher computational complexity than the 2D model, so the advantages of the proposed probability-based approach can be greater.

In FIGS. 7 and 8, a description is given of a probability-based method for determining the position and coordinates of another point adjacent to one point. The method can be applied to both structure analysis and surface analysis for the model matching process described before. This is because both the structure analysis and the surface analysis are basically a process of comparing plural points of different models and producing a matching result.

The structure data and surface data generated by the device may be two-dimensional data represented as a two-dimensional map, or may be three-dimensional data defined on a three-dimensional space. Alternatively, the 3D position surface information can be stored in a 2D map. In this case, the 2D information can be stored together with the 3D position information in a matching fashion.

For structure or surface analysis, the device can extract features or feature points from 2D or 3D data. For example, the device can generate feature data from 2D data or 3D data by using intensity, surface normal, curvature, vein, skin line, and relationship between features. Such feature data can be generated as a rate of change in position or time. As an illustrative example, the parameters utilized by the device can be as follows: i) intensity first derivation, intensity second derivation, or intensity N-th derivation; ii) surface normal, or surface normal N-th derivation; iii) surface curvature, or surface curvature N-th derivation; and iv) line gradient (for a line extracted from the human body such as vein or skin), or line gradient N-th derivation (for a line extracted from the human body such as vein or skin). The device may use one or more of the above parameters to extract v) inter-feature relationship as feature data. Alternatively, if the device is observing the structure or surface of the object, the device may extract features with respect to a change in spatial position, rotation, direction and time from signal strength, surface, structural dynamics, human body feature information, and inter-feature relationships. Since the information thus generated includes position and direction (vector) information, the 6 DOF necessary for model matching can be generated. When matching the 6 DOF of model 1 with the 6 DOF of model 2, the device can produce a higher matching similarity by comparing feature information for each point. Here, in the case of using the relative 6 DOF that transforms model 1 to model 2, the device can transform the vector of a feature of model 1 to model 2 to thereby obtain the vector of the feature of model 2 and the similarity.

Method for Dynamic Equilibrium

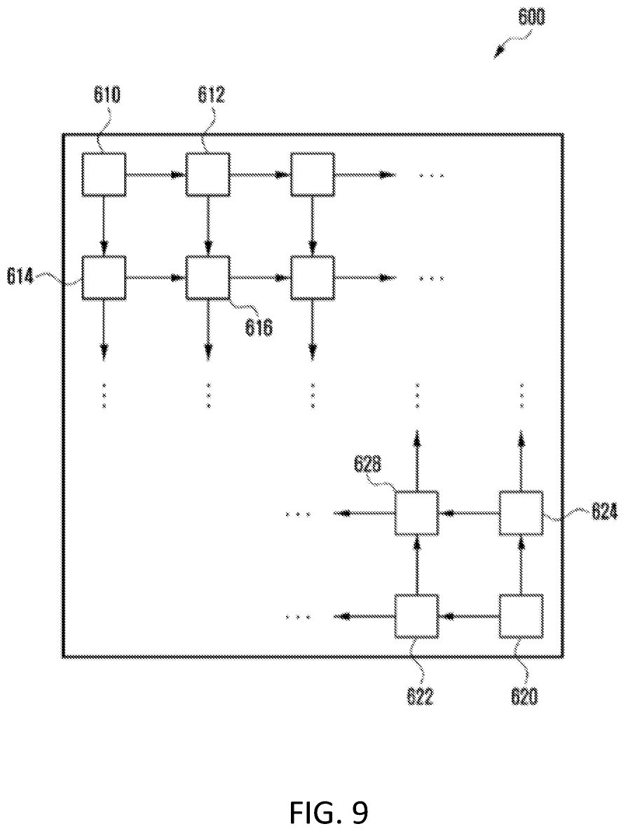

FIG. 9 illustrates a surface analysis process in accordance with various embodiments of the present technology. The proposed surface analysis process is based on the polymorphic theory. The polymorphic theory is a concept that, under the assumption that the points on the surface of an object makeup an elastic body having elasticity, the surface changes in accordance with the motion of the object and the amount of change is affected by adjacent points.

The plane shown in FIG. 9 is a two-dimensional representation of the surface of a two-dimensional or three-dimensional object. This is because the surface of a three-dimensional object can also be represented in two dimensions at a specific point in time. In the plane shown in FIG. 9, the points constituting the surface influence each other and are influenced by each other. For example, the 6DOF value for point 610 may be calculated according to the embodiment described above, and this value may refer to the 6DOF value of point 610 itself or the 6DOF value between point 610 and the point matching point 610. This calculation result affects the calculation of 6DOF values for adjacent points 612 and 614 according to the probability theory described in FIG. 4. Next, the 6DOF value calculated at points 612 and 614 affects the calculation of the 6DOF value of another adjacent point 616. In other words, the 6DOF value calculated for a given point (e.g., point 616) at a particular position is affected by the calculation results of adjacent points. The degree of influence can be determined based on a specific probability as if there is an elastic modulus between the points constituting the surface. This probability corresponds to the probability theory described above in FIG. 4.

Likewise, the 6DOF value calculated at point 620 affects points 622 and 624, and the 6DOF values calculated at points 622 and 624 affect the 6-DPF calculation of point 626. This calculation process is performed in sequence for all the points constituting the surface data while influencing adjacent points like a wave. Thus, the points located at the center of the surface data are more and more influenced by the computation results of surrounding points. As these points may be required to simultaneously satisfy the effects transferred via various paths, the 6DOF computation process can rapidly reach a reduced set of conclusions. That is, as the 6DOF calculation process proceeds for the entire surface data, the computation can gradually become faster. This process of calculating the surface data can be applied to the process of finding the position, direction, and rotation in the structure data. As an illustrative example, when the above method is applied to the structure data, the probability range of one point determines the probability range of an adjacent point within the range of a point, line, network, and area. For example, when a line of model 1 is compared with a line of model 2, if a point of the line of model 1 is matched with a point of model 2, this calculation result affects the probability range calculation for adjacent points belonging to the lines being analyzed.

Meanwhile, the 6DOF calculation process for the surface data can be understood as a process of performing model matching by comparing the surface data of different models similarly to the structure analysis process described above. That is, for each point constituting the surface data, the 6DOF value is calculated and compared to the 6DOF value of another model to check if the two points are matched. If the 6DOF values of two points are aligned side-by-side, it can be determined that the two points are matched. If one point is matched, whether another adjacent point is matched is determined based on the polymorphic theory and probability theory described previously, and this calculation process is performed in sequence on the entire surface data.

When the object is the back of a hand, as the back of the hand is bent or rotated, the surface data of one model may not substantially correspond to the surface data of another model. To cope with such a case, the system performing model matching can extend some surface data to create a virtual surface, and such an extension process can be performed based on the probability theory. Since the structure and the surface combine to form a model, the structure corresponding to the extended surface also needs to be generated. Accordingly, the device may extend the structure data to generate a virtual structure together. By use of the extended structure data and surface data, a sufficient number of data sets can be obtained for performing model matching.

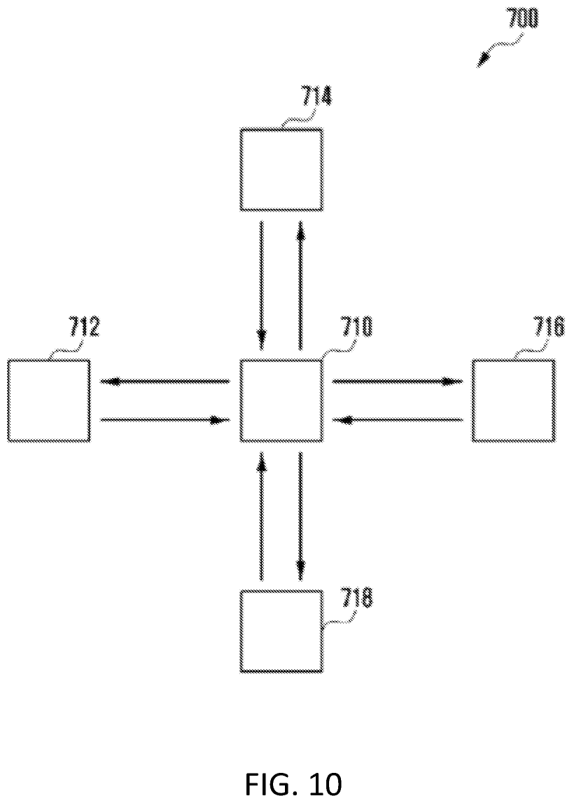

FIG. 10 illustrates dynamic equilibrium in the surface analysis process in accordance with various embodiments of the present technology. As the surface analysis process described above is performed, the surface data is matched and all the data are compared, leaving no additional comparison. Here, to explain the basic concept, it is assumed that the object is fixed although the object may move continuously in real time and the surface data may change dynamically. After completing the calculation for all the surface data collected by the device, points 710, 712, 714, 716 and 718 no longer affect each other. This state is called dynamic equilibrium. The dynamic equilibrium is a state in which the calculation is completed for the influence in consideration of the elastic modulus between the adjacent points or the rate of change in direction and rotation. On the other hand, reaching the dynamic equilibrium state may not necessarily mean that the model matching has been successful. That is, the dynamic equilibrium state can represent that the analysis of surface data for given matching data is completed, but the result may not guarantee that the matching with another model is successful. It may also be understood that dynamic equilibrium is a state in which the effects of all points on a given point are completely calculated. Every point affects adjacent points. Such a chain effect may indicate that the probability influence of a distant point is delivered to a given point through chain point probability calculation.

In addition, when new surface data is generated owing to an additional matching or time-based motion occurring at a different position of the object while the dynamic equilibrium is maintained, the dynamic equilibrium is no longer maintained and a new analysis process can be performed based on the updated surface data. Here, the elastic modulus between adjacent points may not increase or decrease exponentially, and the object may not change its shape in an infinitesimal instant. Hence, once the dynamic equilibrium state has been reached, it can be expected that a subsequent change of the object falls within a preset threshold range, and the device may analyze the updated surface data in consideration of such information.

Tracking/Authentication Method

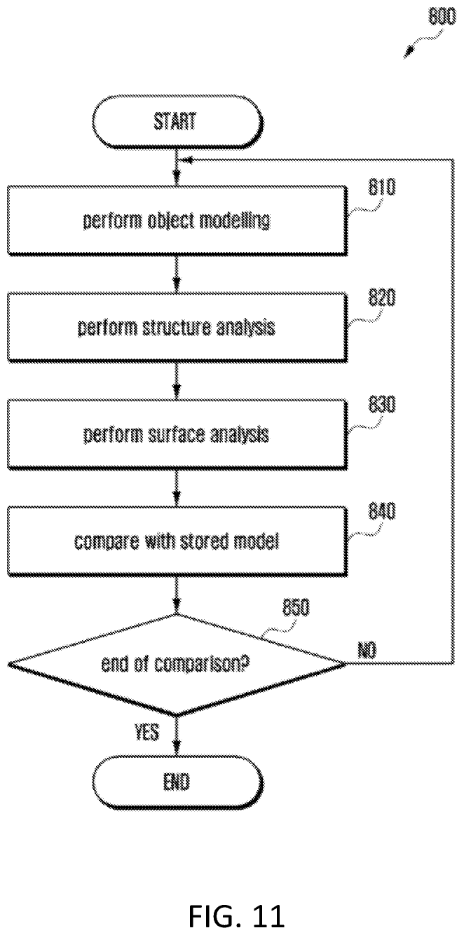

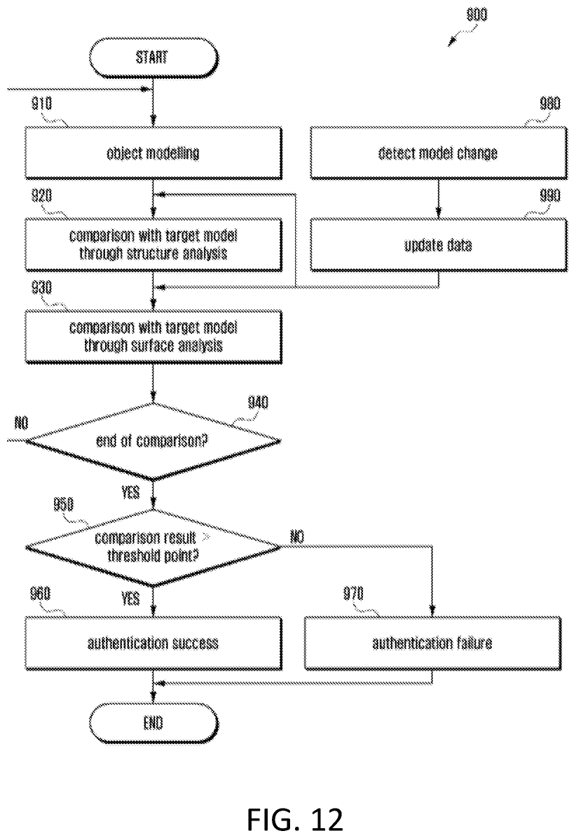

Hereinabove, a description is given of an embodiment for performing model matching through structure analysis and surface analysis based on the concepts of probability theory, structure theory, polymorphic theory, and 6DOF. Next, a model matching method is described in a time series manner with reference to FIGS. 11 and 12. Here, since the embodiments described below operate on the basis of the embodiments described before, the descriptions relative to the foregoing drawings may be applied in an identical or similar way even if a detailed description is omitted.

FIG. 11 is a flowchart of a model matching method in accordance with various embodiments of the present technology. First, the device performs object modeling (810). Object modeling refers to a process of generating two-dimensional or three-dimensional data of an object and storing the generated 2D or 3D data. The device or system can collect data about an object by using one or more of various sensors to perform modeling of the object. For example, the device can generate data on the surface of the back of the hand by imaging the back of the hand or sending and receiving optical signals and can generate vein structure data. Since modeling is a concept including both the structure and the surface as described earlier, performing object modeling can include both data processing for the structure and data processing for the surface.

The device or system can store and manage data of the object modeled at a specific point in time. The object model managed by the device can be compared with another model. Since the device can perform object modeling in real time, the model generated using data collected at a specific moment can be compared with a model stored and managed in advance.

A detailed description is given of the process by which the device performs model matching. First, the device performs an analysis of the structure among the structure and the surface constituting the model (820). This order is for convenience of description. In the model matching process, surface analysis may be performed first, or structure analysis and surface analysis may be simultaneously performed.

The system analyzes the structure of the model to be compared and the structure of the target model, and the structure theory and probability theory described above can be applied to this analysis process. That is, the system may calculate 6DOF values for a plurality of points constituting the structure data and find a relative 6DOF value or a matching point by comparing the 6DOF values with the corresponding 6DOF values of another model. At this time, the device may form a line with priority given to a bifurcation point or a feature point among a plurality of points on the basis of the structure theory, and can continue the analysis process toward another point. In addition, when calculating the 6DOF value or relative 6DOF value for the adjacent point during the analysis process, the device can specify a probability range that can be derived from the calculation result of the previous point on the basis of probability theory. This probability-based approach may reduce the computational complexity and the amount of computation required to compare all points in a 1:1 fashion.

Upon determining that a structure matching is found between the two models through the structure analysis process, the device then performs the surface analysis process (830). In the case of a model whose structure analysis is completed, the 6DOF values or the relative 6DOF values of the points constituting the structure can be reflected, and the surface analysis is likely to proceed successfully. Hence, the device performs the surface analysis on the model whose structure analysis is completed. The polymorphic theory and the probability theory described before can be applied to this analysis process. The device computes 6DOF values for a plurality of points constituting the surface data and compares them with 6DOF values of the other model to find the matching points. Here, the device applies the probability value, which has been applied to calculating 6DOF values in the structure analysis, to the surface analysis. As described above, this is because, in the case of the model whose structure analysis is completed, the surface analysis is likely to be completed. However, the device may also use a probability value for the surface analysis different from the probability value used for the structure analysis. The surface analysis process may be performed in sequence while adjacent points mutually affect each other as described before with reference to FIG. 8.

Method for Model Matching Process

Upon completing the surface analysis, the device examines the result of comparison with the stored model (840). If the structure analysis and surface analysis are successfully completed, the device can determine that a matching is achieved between the model to be compared and the target model. Here, if the object being compared has been moved, the structure data and the surface data are updated and the comparison continues. In this case, the device can perform the process of object modeling, structure analysis, and surface analysis again (850).

In some embodiments, the device may apply scaling in the structure analysis and surface analysis. Here, scaling means that matching may be performed on a partially extracted set of candidate data. On the other hand, scaling also can be conducted by performing the matching with blurred image data (2D, or 3D). For example, Gaussian blur could be used and it can have a similar effect as partial candidate data extraction. As an illustrative example, the device may extract some data (e.g., ½, ¼, ⅛, 1/16) from all of the structure data and the surface data, and perform structure analysis and surface analysis for the extracted data. The device may extract some number of pixels from all of the pixels of a data, instead of extracting the data. This scaling scheme has the advantage of reducing the calculation time in that it reduces the number of points to be model-matched. The device can adjust the probability value or compensate for the 6DOF values in the matching process using the extracted candidate data so that the result value can have sufficient reliability, such as when scaling is not applied.

When structure matching and surface matching are completed for the scaling result from the data, the probability value of the completed data can be transferred to the scaled-up data. For example, if the inter-model probability range for the 1/16-scale cell data of the structure and surface data is sufficiently narrowed, the resultant probability range can be transferred to the ⅛-scale cell data. The ⅛-scale cells have more data including 1/16-scale cells. The probability range of a ⅛-scale cell may be calculated by adding the error due to the scale increase to the probability range of the corresponding 1/16-scale cell. This probability scaling technique can be used to obtain a large-scale probability range with a small amount of computation.

FIG. 12 is a flowchart of a model matching method in accordance with various embodiments of the present technology. FIG. 12 illustrates another embodiment of the model matching method that can be carried out in conjunction with the embodiment described in FIG. 11.

The device performs object modeling (910). The device compares the model to be compared with the target model by analyzing the structure and the surface constituting the object model (920, 930). On the other hand, since the model matching is performed in real time, the object can move or be moved during this model matching process. Accordingly, if the device detects a change of the model due to movement of the object (980), the device may collect data about the changed model and update the structure data and the surface data (990). The device may collect data about the dynamically changing model and perform model matching in real time. The device may continue model matching until the comparison is ended (940).

Meanwhile, upon determining that the dynamic equilibrium state has been reached or sufficient model matching has been achieved even though the dynamic equilibrium state has not been reached, the device checks whether the number of successful comparison results among the entire data for the matching with another model is greater than or equal to a threshold (950). If the probability ranges of the 6DOF value or relative 6DOF value of a point on the surface and structure converges or is less than or equal to the threshold, the point can be regarded as a matching point. If the number of results from matching between the two models is greater than or equal to the threshold, as the two models can be regarded as identical, the device determines that the model matching has been successfully performed and the authentication is successful (960). If the number of results from matching between the two models is less than the threshold, the device may determine that the two models are not the same and determine that the authentication based on model matching is unsuccessful (970). If the two models are not identical, the dynamic equilibrium described above may not occur or the results of the probability calculations between points may not match each other. For example, the probability influence of all other points on a given point can be calculated, and the probability common denominator for the influence of each point may not exist. If there is a contradiction in the probability calculation, the degree to which the probability calculation differs from or is inconsistent with the dynamic equilibrium state can be measured numerically, which can be a criterion for determining the discrepancy between the two models.

The model matching method described above can generate models including data about the vein structure and the skin surface, compare the structures in the matching between the generated models, and compare the surfaces probabilistically, thereby improving the speed and accuracy of the model matching. This matching technique can be applied to the process of tracking and authenticating some or all of the human body including the hand or face. In addition, through this matching technique, facial expression detection, emotional change detection, and human health monitoring can be performed. Further, it is possible to provide various biometric data, 6DOF data of the human body surface, and a 3D human body model.

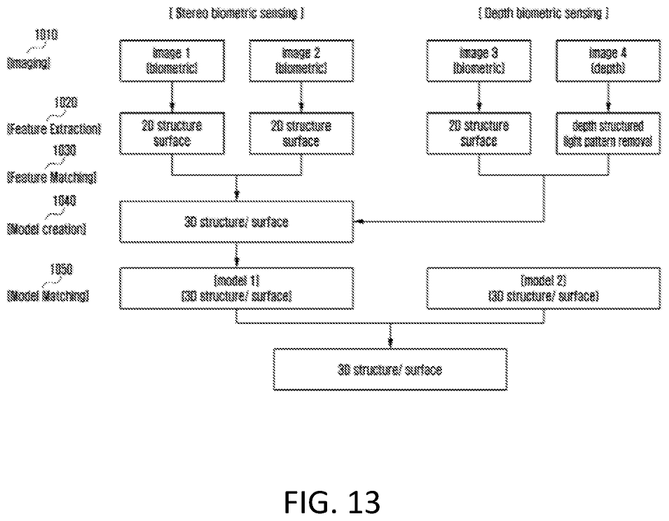

FIG. 13 shows flowcharts of a model matching with stereo biometric sensing and depth biometric sensing. As described above and shown in FIG. 13, model sensing can be performed by using different types of sensors. The system can perform imaging process (1010) with sensors for biometric sensing (i.e., stereo biometric sensing); thereby obtain two or more images. Here, the system can also perform another imaging process with one or more sensors for biometric sensing and/or one or more sensors for depth sensing.

The system can extract feature points (1020) from the plurality of images 1, 2, 3, 4 to generate 2D structure/surface data for each of the images. The system can also process the image 4, which is obtained by depth sensor, by removing depth structured light pattern from the image. And, the system matches the extracted feature points to create a 3D model (1030, 1040). The system can utilize the depth data by merging the depth data from image 4 to create 2D or 3D biometric model (model 1). The system can create another 3D model (model 2) by repeating the above procedures, and match a plurality of models (1050).

Method of Vein Motion Signatures

The matching techniques could also recognize the 6DOF in/of the structure and the surface as unique elements which have their own characteristics and features and could identify/monitor them in a duration of time (6DOF continuous authentication or 6DOF tracking). The sequence of the 6DOF changes in a time period creates a motion signature of the 6DOF of the biometric model (vein pattern). In this process, any changes or motion from body movements generate unique biometric data which reflects human skeleton, skin, vein, and other biometric components' dynamics. Like the biometric data, the motion data of the biometrics is also identical to each other.

The vein motion signature (or the biometric motion signature) could be used for a creation and a matching of a motion model. The motion model maybe a time series data which the 6DOF data, the structure data, or the surface data should (could) be located in a designed matter, such as positions and rotation (orientation) time-sequentially. The motion model matching may be a process that compares two motion models by performing the model matching techniques from the first motion model to the second motion model, which may be time series 6DOF changes recorded or machined learned.

The biometric motion modeling method could be used for user identification, user activity authorization, money transaction, and any other credit required activities. This method may offer an extremely high level of biometric copy protection and could be reproduced repeatedly by users.

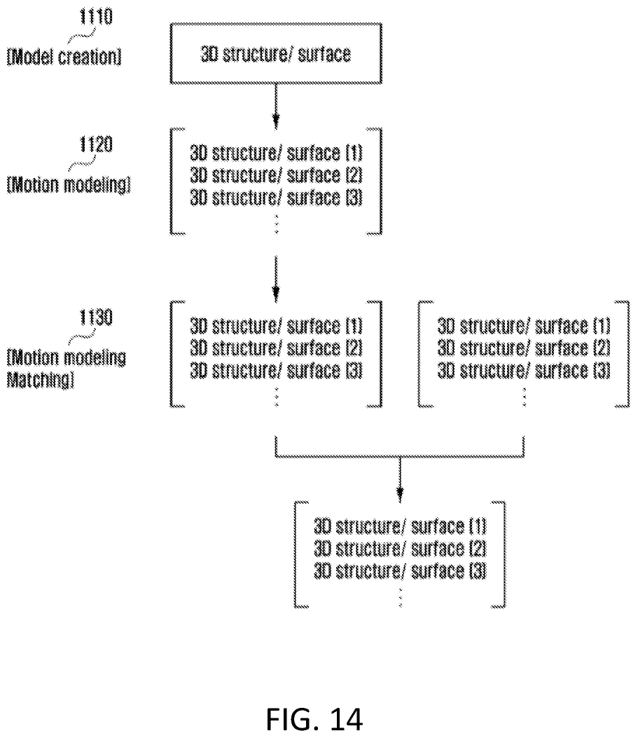

FIG. 14: Model Matching Process Flow

FIG. 14 shows flowcharts of a motion model matching in accordance with various embodiments of the present technology.

After creating a 3D model (1110) as described in FIG. 13, the system can monitor the 3D model for a duration of time to create a motion signature (i.e., motion modeling, 1120). The sequential 6DOF changes of the 3D model can be represented as a motion signature of the biometric 3D model. The motion model matching (1130) can be performed by comparing two motion models according to the model matching techniques from the first motion model to the second motion model, which may be time series 6DOF changes recorded or machined-learned.

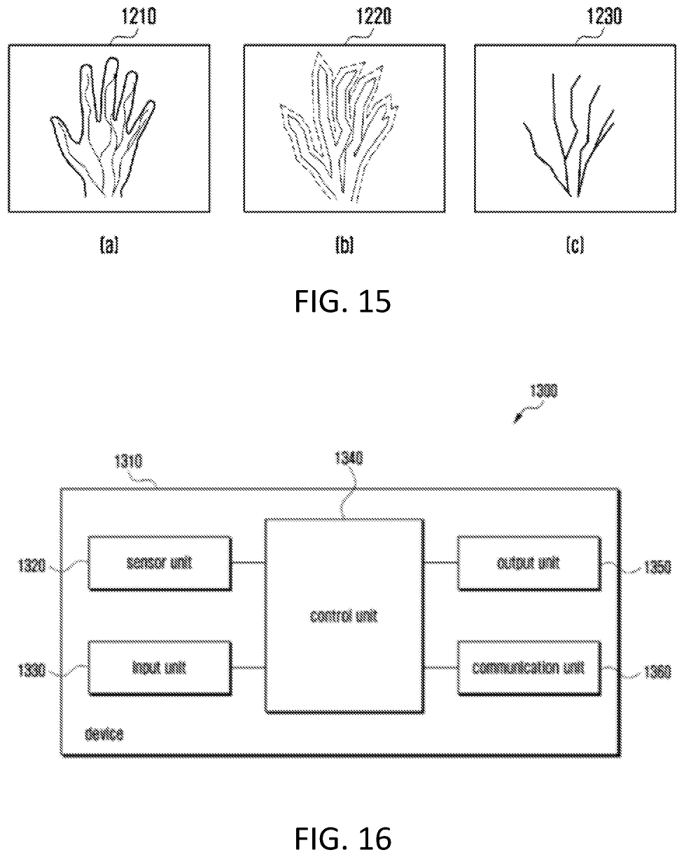

FIG. 15: Motion Model Matching

FIG. 15 illustrates an example of motion modeling in accordance with various embodiments of the present technology. Image 1210 of the FIG. 15 shows an obtained biometric image of an object. Image 1220 shows the motion signature obtained by monitoring the 3D model for a time period. Lastly, the image 1230 shows featured points extracted from the image 1210.

System/Device Structure

FIG. 16: System Process

FIG. 16 is a block diagram of a system (or a device) performing model matching in accordance with various embodiments of the present technology. In one embodiment, the device 1310 may include a sensor unit 1320, an input unit 1330, a control unit 1340, an output unit 1350, and a communication unit 1360. However, the configuration shown in FIG. 16 is merely an example, and a new component may be added to the shown configuration or an existing component may be omitted from the shown configuration.

The device 1310 may utilize the components shown in FIG. 16 to perform model matching as described before in connection with previously described embodiments. As an illustrative example, the sensor unit 1320 can generate structure data and surface data of the object by utilizing one or more sensors of different types. The sensor unit 1320 may include multiple sensors operating based on different principles to collect data. Alternatively, the sensor unit 1320 may obtain the same result through post-processing of the data collected via one sensor.

The input unit 1330 receives a user input from outside the device 1310. For example, the input unit 1330 may include a user interface for sensing input from the user of the device 1310.

The output unit 1350 outputs the results of processing performed by the device 1310 to the outside in various ways such as visual, auditory, and tactile senses. For example, the output unit 1350 may include a display and a speaker. The communication unit 1360 may connect the device 1310 with an external device, a server, or a network, and may include a wireless communication module and a wired communication module.

The control unit 1340 generally controls the components of the device 1310 to perform model matching according to the above-described embodiments. For example, the control unit 1340 may perform the structure analysis and surface analysis based on the model data collected by the sensor unit 1320, may reflect the value received through the input unit 1330 in the analysis process, may output the analysis result to the outside through the output unit 1350, or may transmit the analysis result to another device or server through the communication unit 1360.

Meanwhile, the model matching method described above can be implemented as a program (or code) that can be executed by a computer, can be stored in a computer readable storage medium, and can be carried out by a computer system that decodes the program. Further, the data structure used by the above-described method can be recorded on the computer-readable recording medium through various means. The storage media in which the program or code for carrying out various embodiments can be stored may include a ROM (read only memory), a RAM (random access memory), a CD-ROM, a DVD, a magnetic tape, a floppy disk, a hard disk, and an optical storage device. The program stored in a computer-readable storage medium may be stored and managed by a computer system connected via the network in a distributed manner, and may be stored and executed as computer-readable code in a distributed manner.

Hereinabove, various embodiments have been shown and described for the purpose of illustration without limiting the subject matter. It should be understood by those skilled in the art that many variations and modifications of the method and apparatus described herein can still fall within the spirit and scope of the present technology and their equivalents.

Method for Multi-Path Matching (Probability Spaces)

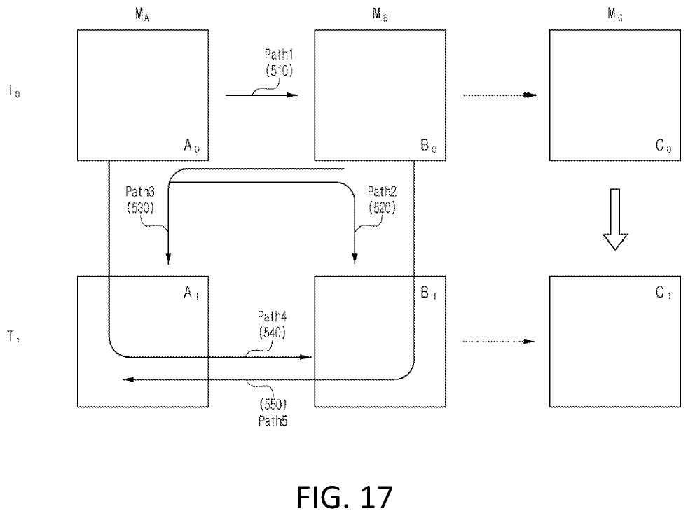

The process of associating a plurality of frames with each other (or probability sharing) may be performed via multiple paths among the frames. For example, a path 1 510 of FIG. 17 is a path in which a frame AO is matched against a frame B 0.

FIG. 17 is a diagram illustrating multi-path matching according to an embodiment of the disclosure.

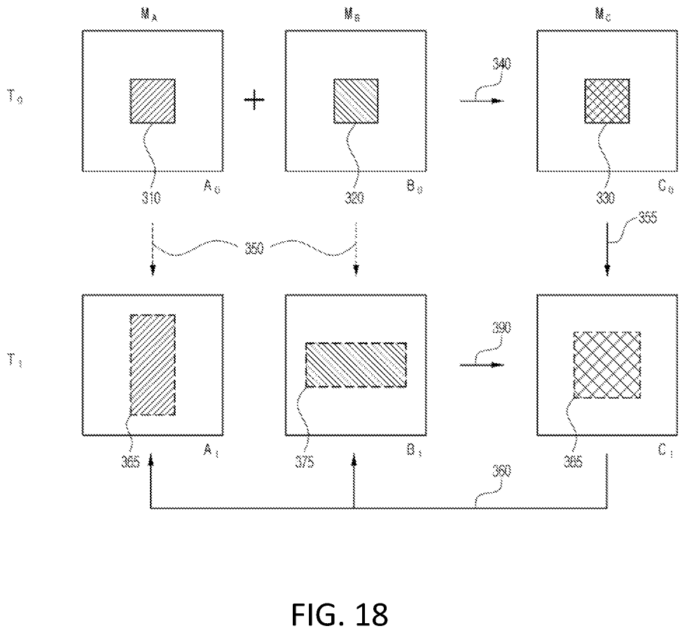

Through the above, frame CO is extracted and frames C 1, A_1, and B 1 are determined according to the process of FIG. 18. When a matching process is performed along Path2 (520), the frame A_O is matched against the frame B 0, the frame CO is extracted, and the frame BO is matched against the frame B 1. Irrespective of determining the frame B_1 along the path 1, the frame B 1 may be determined along the path 2. The location of a unit in the frame B 1 may be specified on the basis of the intersection of probability ranges determined via the two paths. Similarly, along a path 3 530, matching is performed between the frames AO and B 0, together with matching between the frames AO and A 1. Along a path 4 540, matching is performed between the frames AO and A_1, together with matching between the frames A 1 and B 1. Along a path 5 550, matching is performed between the frames BO and B 1, together with matching between the frames B 1 and A 1.

The process of sharing probabilities among the sensor frames may be performed via a plurality of paths, and this matching process is referred to as Multi-Path Matching. As probability sharing is continuously performed among frames via a plurality of paths, the intersection of probability ranges gradually decreases. When the location of units in all frames is sufficiently narrow, a balance may be obtained, and the locations of units may be specified.

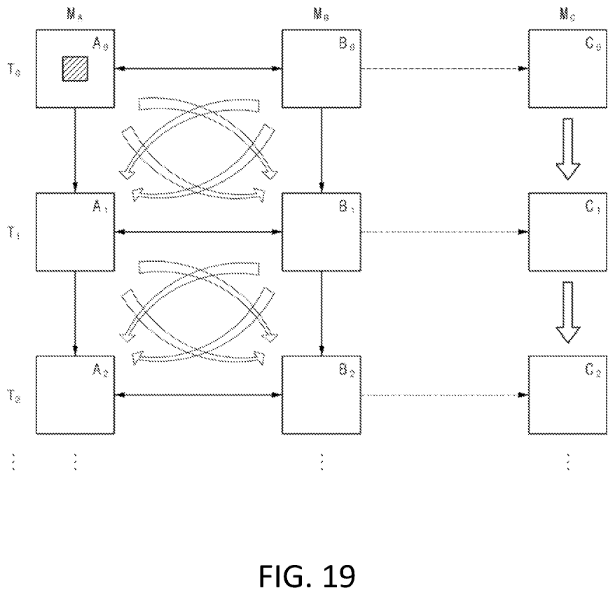

FIG. 19 is a diagram illustrating multi-path matching according to an embodiment of the disclosure. The process of probability sharing and multi-path matching among the six frames at the points T 0 and T 1 have been described with reference to FIG. 17. The biometric system may perform such matching process for two or more predetermined points in time. The biometric system may perform the matching process many different points at multiple, different points in time. The biometric system may perform the matching process with respect to continuous or real-time data streams sent by devices about an object in motion or stationary.

Method of Probability Unit Compensation Values

Considering topological properties of points in a model for an object, a probability unit may add compensation values to probability ranges when estimating the state of the next probability unit. The compensation values may include information related to the displacement in space, a predetermined value, an adjustable value, experimental or learned information. This method offers the ability to more explicitly inject biological deformation properties and constraints into the matching and tracking processes through compensation values. In addition, machine learning approaches may be used to learn the unique biological properties and constraints of particular structure and surface points over time or from large training datasets.

In the case of probability units having individual or learned information, they may have unique behavior when computing adjacent probability units. A dynamic equilibrium state may be sustained between probability units with the diverse types of compensation methods applied. Due to the compensation choices for probability units, the probability ranges for a comparison model may have various topological shapes that have unique elastic characteristics in structure and surface elements.

1. A method for a system to perform 3D model creation and matching, the method comprising:
building a model for an object, the model including structure information about the object;
generating a first probability unit of the model, wherein the first probability unit includes a first probability distribution of a state of the model and a second probability distribution of a state of the object;
comparing the first probability unit with a second probability unit generated through observed data of the object, via a matching path based on the structure information;
generating a related probability distribution associated with the matching path; and
predicting the state of the object based on the related probability distribution.

2. The method of claim 1, wherein the state of the model includes position, orientation, 6 degrees of freedom (6DoF), velocity, acceleration, color, and/or element types.

3. The method of claim 1, wherein an identified part in the model is associated with the first probability unit, wherein the identified part corresponds to a part in the object with respect to the related probability distribution.

4. The method of claim 1, wherein the comparing is performed via a plurality of matching paths, including the matching path based on the structure information, for comparing the structure state of the model with a plurality of structure states of the object.

5. The method of claim 4, wherein the comparing is performed for a plurality of points of a state of the model by propagating along a network or on a surface of the object.

6. The method of claim 5, wherein a scheme is utilized to predict a state estimate of a next point of the model, and wherein the scheme includes surface geometry, surface tension and/or a surface elasticity system of the object.

7. The method of claim 6, wherein the state estimate of the point is selected based on a maximum likelihood estimation.

8. The method of claim 1, further comprising:
calculating a state of a point of the model from the related probability distribution; and
updating the state of the point according to the probability distribution changes.

9. The method of claim 1, wherein the observed data of the object represents state data pre-stored in the system or is a data stream generated in real time.

10. The method of claim 1, wherein the related probability distribution is generated by sharing a result of the comparing along the matching path, and wherein the result of the comparing comprises a differential state between the first probability distribution and the second probability distribution.

11. The method of claim 10, further comprising:
calculating the differential state from the related probability distribution; and
balancing the state of the model by continuously adjusting the differential 6DoF value.

12. The method of claim 3, wherein the identified part is time-sequentially updated by tracking, transformation, or deformation of the model according to a change of the related probability distribution.

13. The method of claim 1, wherein the model is built using one or more sensors, and wherein the sensor comprises one or more of a stereo sensor, a time-of-flight (TOF) sensor, a depth sensor, an RGB sensor, an infrared sensor, or a thermal imaging sensor.

14. The method of claim 1, wherein the model is built using data stored in the system.

15. The method of claim 1, wherein the structure information of the model represents blood vessel, skin, or surface geometry and topology in a body part of a person.

16. The method of claim 1, wherein the method is applied to at least one of a hand segmentation in 2D, a hand segmentation in 3D, a hand collision with other hands in 2D, a hand collision with other hands in 3D, a hand-object interaction, an elemental ID tracking, a motion tracking, a virtual-reality application, an augmented-reality application, a mixed-reality application, or a combination of hands and a virtual object surrounding the hands using a 3D coordinate system.

17. The method of claim 1, wherein the system comprises a sensor, a processor configured to process data, an input/output (I/O) unit, a memory, a communication unit, or a combination thereof.
